(19) United States
(12) Patent Application Publication
(10) Pub. No.: US 2025/0202722 A1
(43) Pub. Date: Jun. 19, 2025

(54) BLOCKCHAIN TRANSACTION

(71) Applicant: nChain Licensing AG, Zug (CH)

(72) Inventors: Craig Steven WRIGHT, London (GB); Mathieu DUCROUX, London (GB)

(21) Appl. No.: 18/838,089

(22) PCT Filed: Jan. 16, 2023
(86) PCT No.: PCT/EP2023/050831

§ 371 Date: Aug. 13, 2024

(30) Foreign Application Priority Data
Feb. 15, 2022 (GB) 2201962.4

(51) Int. Cl. H04L 9/00; H04L 9/08; H04L 9/32

(52) U.S. Cl. CPC H04L 9/50; H04L 9/0861; H04L 9/3271

(57) ABSTRACT

A computer-implemented method for generating a puzzle blockchain transaction. A first locking script of the puzzle blockchain transaction is provided, the first locking script corresponding to a first unspent transaction output and comprising a hash value derived from a target solution of a time-lock puzzle, and a set of puzzle parameters of the time-lock puzzle. The target solution is computed using a set of secret puzzle parameters. The time-lock puzzle is solvable using the set of puzzle parameter in a time equal to or greater than a minimum solving time. The set of puzzle parameters does not comprise the secret puzzle parameters. The locking script is configured to, when executed with a first unlocking script of a solution blockchain transaction, verify a candidate solution, computed using the set of puzzle parameters, provided in the first unlocking script of the solution blockchain transaction based on the hash value.

### CROSS REFERENCE TO RELATED APPLICATIONS

This application is the U.S. National Stage of International Application No. PCT/EP2023/050831 filed on Jan. 16, 2023, which claims the benefit of United Kingdom Patent Application No. 2201962.4, filed on Feb. 15, 2022, the contents of which are incorporated herein by reference in their entireties.

### TECHNICAL FIELD

The present disclosure relates to a method for generating blockchain transactions, wherein the output of the transaction is time-locked, and a method for generating a blockchain transaction for unlocking the time-locked output.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

In some scenarios, it is desirable to create transactions with outputs that can only be spent after a specific amount of time. This can be achieved to a certain extent by nLocktime, using which the whole transaction is only committed to the blockchain after the nLocktime has elapsed, such that the UTXOs can only be spent after nLocktime. However, this method does not enable only some of the transaction's UTXOs to be locked and implies that the transaction is stored locally rather than in an immutable way on the blockchain.

A blockchain transaction is provided herein in which time-lock puzzles are used to lock UTXOs of the transaction, stored on-chain, that can only be spent after a specific amount of time.

According to one aspect disclosed herein, there is provided a computer-implemented method for generating a puzzle blockchain transaction, the method comprising: providing a first locking script of the puzzle blockchain transaction, the first locking script corresponding to a first unspent transaction output and comprising a hash value derived from a target solution of a time-lock puzzle, and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, wherein the locking script is configured to: when executed with a first unlocking script of a solution blockchain transaction, verify a candidate solution, computed using the set of puzzle parameters, provided in the first unlocking script of the solution blockchain transaction based on the hash value; and making the puzzle blockchain transaction available to one or more nodes of a blockchain network.

Time-lock puzzles require users to perform a precise number of sequential computations such that parallelising the solving process does not speed up finding the solution. This also has the consequence that the solving time of the puzzle can be estimated in advance if the hardware of users is known.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 schematically illustrates an example method for unlocking a UTXO using a solution to a time-lock puzzle,

FIG. 5 schematically illustrates an example method for unlocking a UTXO using a time-locked private key which is not associated with a specific user,

FIG. 6 schematically illustrates an example method for unlocking a UTXO using a time-locked private key which is associated with a specific user,

FIG. 7 schematically illustrates an example method for unlocking a chain of UTXOs using time-locked private keys which are not associated with a specific user,

FIG. 8 schematically illustrates an example method for unlocking a chain of UTXOs using time-locked private keys which are associated with a specific user,

FIG. 9 schematically illustrates a chain transaction comprising multiple outputs forming a time-locked chain,

FIG. 10 shows an example method for preventing a UTXO from being spent until after a minimum solution time, and

FIG. 11 shows schematically illustrates an example method for unlocking a chain of UTXOs where spending transactions contain a next puzzle to be solved.

### DETAILED DESCRIPTION OF EMBODIMENTS

### 1. Example System Overview

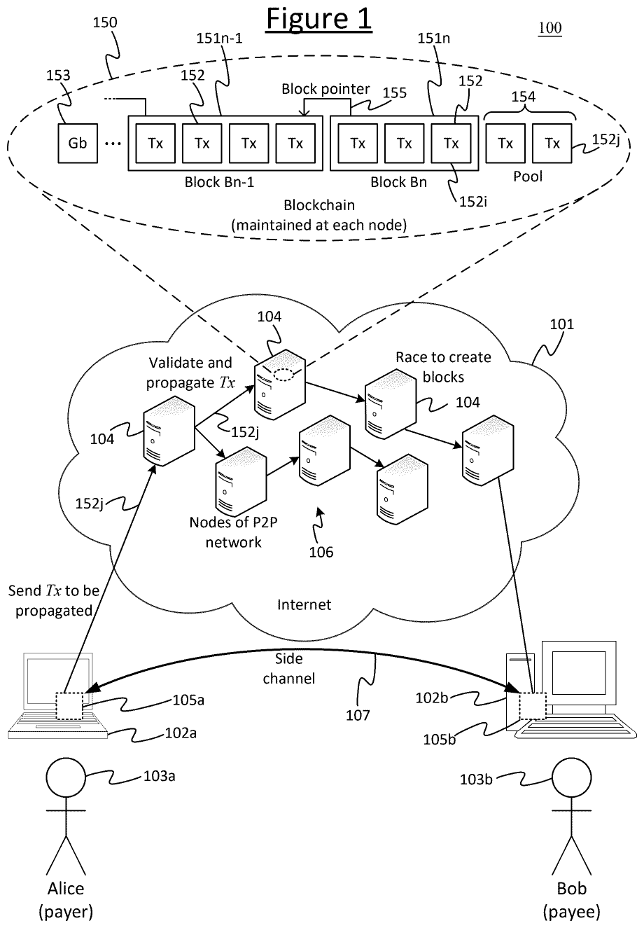

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

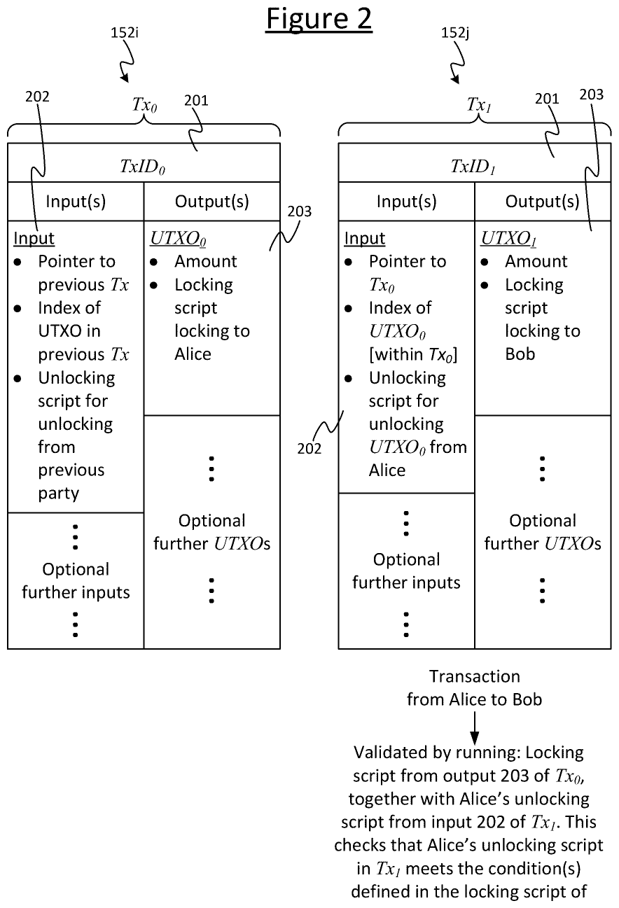

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Node Software

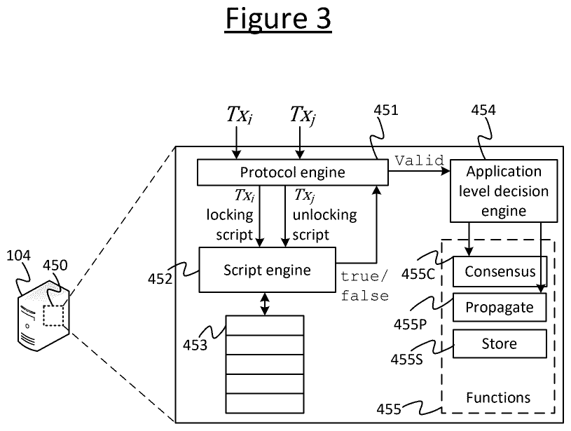

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 5. Time-Locked UTXO

Time-lock puzzles can be used as set out below to lock UTXOs of transactions stored on-chain that can only be spent (i.e. unlocked) after a specific amount of time.

Time-lock puzzles require users to perform a precise number of sequential computations such that parallelising the solving process does not speed up finding the solution. This also has the consequence that the solving time of the puzzle can be estimated in advance if the hardware of users deriving the solution is known.

Time-lock puzzles can be used to construct chains of time-locked UTXOs, where solving one puzzle allows a user to solve the puzzle for the next UTXO. By chaining locked UTXOs, it is ensured that a UTXO in a chain cannot be spent unless all puzzles for the previous UTXOs of the chain were solved.

Herein, a party generating the puzzle is referred to as a “challenger”, while a party solving the puzzle to unlock the transaction is referred to as a “solution provider” or “puzzle solver”.

### 5.1 Time-Lock Puzzles

Time-lock puzzles require users to spend a specific amount of time solving them. They are intrinsically sequential so that parallelising the computation does not help in finding the solution faster. The solution time of a time-lock puzzle is only approximately controllable since different computers have different processing power. It is advantageous for verifying the solution to a puzzle to take significantly less time than solving it.

Some useful properties of time-lock puzzles include:
Non-parallelisability: the solution cannot be obtained faster than scheduled by distributing the puzzle to multiple machines or CPU cores.
Efficient verification: verifying the solution to a puzzle should be significantly faster than solving it.
Fine hardness granularity: the difficulty of the puzzle can be finely adjusted to different levels.

### 5.1.1 Modular Squaring Puzzles

One example type of time-lock puzzle which is particularly useful in the present implementation is a modular squaring puzzle.

Modular squaring puzzles are time-lock puzzles that require users to compute a squaring operation repeatedly in a multiplicative group of integers modulo n=pq, where p, q are large primes. This puzzle forms the basis of many time-locked puzzles. p and q are large in that they cannot be found from n. They are typically 2048 bits in length, however it will be appreciated that other bit lengths may be used. A bit length of at least 2048 provides a strong security guarantee for the puzzle.

The algorithms defining modular squaring puzzles are the following:
SETUP(1^{k})→ (params, secret): Given a security parameter k, generate a composite modulus n=pq with p, q two large randomly chosen secret primes. Output params=(n) and secret=(p, q). The secret parameter k denotes the length in bits of the modulus n. It may, for example, be equal to 2048.
GENPUZ(t, params)→puz: Pick a random a with 1<a<n. Output puz=(a, t) with t>0, where t is the time parameter.
FINDSOLN(puz, params)→sol: Compute sol=a²^{^{t}} mod n and output sol.
VERSOLN(sol, puz, params, secret)→{0,1}: Compute φ(n)=(p−1)(q−1) using secret=(p,q). Output 1 if sol=a²^{^{t}}^{mod φ(n)} mod n (solution is valid), 0 otherwise (solution is invalid).

The solution of a modular squaring puzzle can be computed by doing log₂ (2^{t})=t modular multiplications when given the puzzle parameters a, t, and n. Computing the solution cannot be done in parallel as each step in the solving process depends on the previous one.

A verifier with knowledge of φ(n)=(p−1)(q−1) can efficiently verify the solution. Using the trapdoor offered by Euler's function a²^{^{t}} mod n=a²^{^{t}}^{mod φ(n)} mod n, the solution can be verified in O(log(n)) modular multiplications.

For users who do not know p and q, computing the squaring operations is considerably faster than computing φ(n), which is provably as hard as factoring n. This guarantees that a successful solver has performed all the repeated squaring operations.

The number t of squarings required to solve the puzzle can be exactly controlled. This allows challengers to create puzzles of various desired levels of difficulty. The control is linear in t, and the solving time can be determined beforehand if the modular squaring speed of users is known. Assuming a challenger wants to create a time-lock puzzle that cannot be solved before T seconds, t should be set such that t≥T. S where S is the number of squarings modulo n per second that can be performed by the user. If the speed of the user is not known, then a lower bound can be set based on the latest hardware capabilities, referred to herein as a minimum solving time.

Modular squaring puzzles are not publicly verifiable, as efficiently verifying the solution requires the knowledge of the secret information φ(n).

Other examples of time-lock puzzles include puzzles based on square roots. While such puzzles may be used to time-lock transactions as presented herein. Modular squaring puzzles are preferred as they provide a wider range of possible time-lock durations, so provide a more tuneable solution.

5.2 Time-Locked UTXOs with Modular Squaring Puzzles

Time-lock puzzles, such as the modular squaring puzzles presented above, may be used to lock UTXOs for a predetermined amount of time. The predetermined amount of time is the minimum solving time T.

In the examples provided herein, a challenger locks an output of a transaction Txₐ for a pre-determined amount of time.

### 5.2.1 Standard Construction

The challenger performs the following steps:
1. Call SETUP(1^{k}) for a given security parameter k to generate (params, secret) and keep the value secret private.
2. Select the time parameter t of the modular squaring puzzle and generate puz by calling GENPUZ(t).
3. Using secret generated in step 1, compute φ(n)=(p−1)(q−1).
4. Pre-compute the solution to the puzzle sol=a²^{^{t}}^{mod φ(n)} mod n using puz, params, and φ(n).
5. Compute the hash of the solution h(sol).

The challenger then generates a transaction with a first locking script comprising the hash of the solution h(sol) and the puzzle parameters a, t, and n. The puzzle parameters are included in the OP_RETURN so that a puzzle solver is able to compute the solution.

The first locking script is associated with a first UTXO, locked by the time-lock puzzle, and can only be spent if the puzzle solver provides, in a first unlocking script of a solution transaction, the solution to the puzzle.

The challenger constructs the locking script as follows:

Locking script :
OP_HASH <h(sol)> OP_EQUALVERIFY
OP_CHECKSIG OP_RETURN <puz =
(a, t)> <params = (n)>

The puzzle puz=(a, t) and the parameter params=(t) are included in the script using OP_RETURN. Including t enables users to estimate the time it will take them to solve the puzzle, and therefore if it is worth investing this effort.

In order to spend the time-locked UTXO, a user has to compute the solution of the puzzle, by calling FINDSOLN(puz, params), using which the solution is computed using sol=a²^{^{t}} mod n.

The unlocking script can then be constructed as follows:

Unlocking script:
<sig> <P> <sol>

That is, the puzzle solver provides, in the unlocking script, their signature sig generated using their private key, the corresponding public key P, and the solution to the puzzle sol.

Here, it is assumed that the challenger is honest. Indeed, a malicious challenger could make users expend an extensive amount of resources without reward by including h(sol′) in the locking script with sol′≠a²^{^{t}}^{mod φ(n)} mod n. This would make it impossible for users to spend the UTXO even if they correctly compute the solution sol.

Using this method, the funds can be redeemed by anyone who computes the solution to the puzzle. However, this construction is vulnerable to “man-in-the-middle” (MITM) attacks. An attacker could intercept a transaction containing the solution to the puzzle, replace the receiving address with their own, and sign the transaction with their own private key. They could then make sure that this modified transaction gets published before the intercepted one, thus stealing the funds redeemed by the legitimate puzzle solver.

To prevent MITM attacks, the transaction could also spend to a particular address by checking that the public key given in the unlocking script hashes to a particular value h(Pₐ) provided in the locking script. However, this the drawback that the transaction can only spend to a particular address.

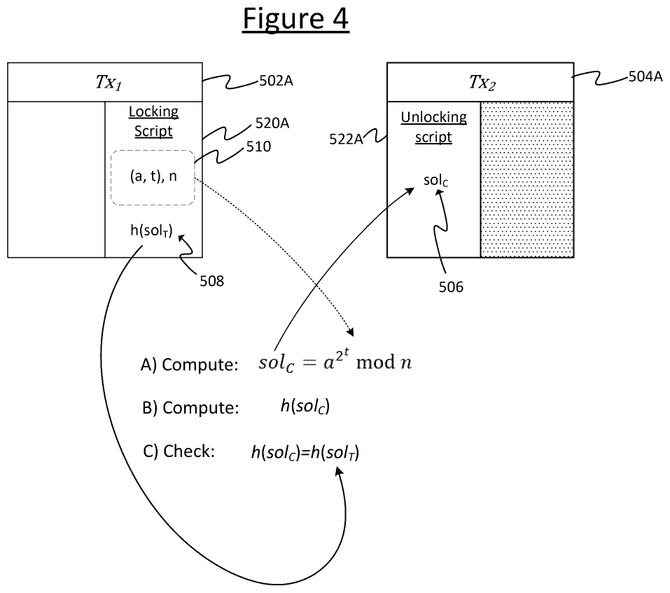

FIG. 4 illustrates the use of the construction set out above to time-lock a UTXO.

The challenger provides the puzzle blockchain transaction Tx₁ 502A which has a first locking script 520A comprising the puzzle parameters 510 and a portion derived from the solution 508, which here is the hash of the solution h(sol). The solution provided by the challenger is referred to as a target solution, denoted sol_{T}. The target solution is computed by the challenger using the large prime numbers p and q.

The puzzle parameters 510 may be provided in the OP_RETURN output to render the puzzle parameters 510 available to other users when the puzzle transaction Tx₁ 502A is committed to the blockchain. OP_RETURN outputs are unspendable. The puzzle parameters 510 may also be provided in a spendable output, e.g. using OP_PUSH and OP_DROP.

The solution provider uses the puzzle parameters 510 provided in the puzzle transaction Tx₁ 502A to compute the solution at step A. The solution computed by the solution provider is referred to as a candidate solution and denoted sol_{C}. The solution provider computes the candidate solution using sol_{C}=a²^{^{t}} mod n in at least the minimum solution time T.

The solution provider generates solution transaction Tx₂ 504A and provides in a first unlocking script 522A the candidate solution 506.

When the first locking script 520A and first unlocking script 522A are run together, the first locking script is configured to compute a hash of the candidate solution 506, step B, and verify that the hash of the candidate solution is equal to the hash of the target solution, step C, and thus verify that the solution provider has computed the solution correctly in at least the minimum computation time T.

The solution provider is able to spend the UTXO associated with the first locking script 520A if the hashes match.

5.2.2 P2PKH with Time-Locked Private Key

The following construction allows puzzle solvers to spend a UTXO locked with a modular squaring puzzle, while ensuring that the spending transaction cannot be modified before it is published on the blockchain.

A P2PKH script can be provided which prevents MITM attacks. This method can be used to allow either anyone to spend a UTXO, locked with a modular squaring puzzle, or to address funds to a specific recipient in a timed basis.

The constructions provided below, therefore, ensure that the UTXO cannot be spent until at least the minimum solving time has elapsed.

### 5.2.2.1 Anyone Can Spend

The private key that can spend the UTXO is bound to the solution of the modular squaring puzzle, such that only users that have computed the solution of the puzzle can spend the UTXO while still allowing any user who is first to compute the solution to spend the UTXO. By signing the spending transaction with a key bound to the solution to the puzzle, the spending transaction cannot be modified by a user that has not computed the solution while still remaining valid.

In this construction, the locking script is a P2PKH where the transaction spends to sk·G, where G is the elliptic curve generator point, sk is a randomly generated private ECDSA key, and sk·G is the corresponding public key. Modular squaring puzzles can be used to encrypt the private key sk, such that it can only be decrypted after a pre-determined amount of time as follows:

$${C}_{s k} = s k + sol mod n$$

where sol=a²^{^{t}}^{mod φ(n)} mod n.

In some embodiments, a²^{^{t}}^{mod φ(n)} mod n may be used as a private key instead. However, this does not guarantee that the result is uniformly distributed across the range of ECDSA private keys, unlike the private key sk.

The encrypted key Cₛₖ is included in the OP_RETURN data, along with the puzzle puz=(a, t) and the parameters params=(n), thus allowing the private key sk to be derived.

To spend the UTXO, a user needs to compute the solution to the puzzle sol=a²^{^{t}} mod n to derive the private key sk=Cₛₖ−sol mod n and unlock the P2PKH script.

The challenger generates the blockchain transaction with a first locking script, corresponding to a first UTXO, which comprises a hash of the public key h(sk·G), the puzzle parameters a, t, and n, and the encrypted key Cₛₖ. The puzzle parameters and encrypted key are included in the OP_RETURN so that a puzzle solver is able to compute the solution.

The locking script may be as follows:

Locking script :
OP_DUP OP_HASH <h(sk · G)> OP_EQUALVERIFY OP_CHECKSIG
OP_RETURN
<puz = (a, t)> <params = (n)> <Cₛₖ = sk + a²^{^{t}} mod n>

The puzzle solver derives the private key sk, and uses this to generate the public key sk·G, which is provided in the first unlocking script of the solution transaction. The public key sk·G is said to be derived from the solution, since the puzzle solver finds sk using sk=Cₛₖ−sol mod n. The puzzle solver also provides a signature sig generated using the derived private key sk. This ensures that the transaction cannot be modified by a user who has not computed the private key sk.

The unlocking script may be as follows:

Unlocking script:
<sig> <sk · G>

The locking script is configured to generate a hash of the provided public key sk·G and verify that it is equal to the hash h(sk·G) provided in the unlocking script.

The locking script is further configured to check that the signature provided in the unlocking script is correct and has been computed using the private key sk.

Therefore, this construction allows anyone to spend a time-locked UTXO. Furthermore, the signature guarantees that a spending transaction not yet published on the blockchain cannot be modified by a malicious actor who has not computed the solution to the puzzle.

Using this method, the solver of the puzzle cannot be identified from the unlocking script as the public key used to unlock the UTXO is the same for all users. In some embodiments, public key addition in-script is used to define that users are required to include their public key in the unlocking script, in addition to providing the solution to the puzzle.

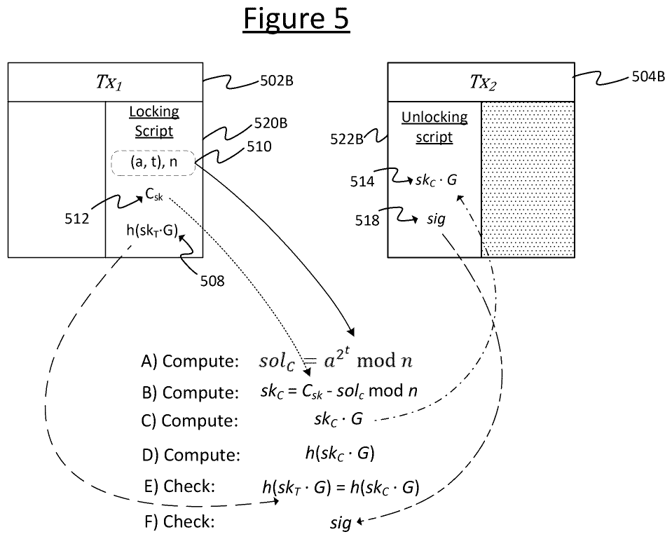

FIG. 5 illustrates the use of the anyone can spend P2PKH construction set out above to time-lock a UTXO.

The challenger provides the puzzle transaction Tx₁ 502B which has a first locking script 520B comprising the puzzle parameters 510, the encrypted key Cₛₖ 512 and a portion derived from the solution 508, which here is the hash of the public key derived from the solution h(sk·G). The private key provided by the challenger is referred to as a target private key, denoted sk_{T}. The target private key is computed by the challenger using the large prime numbers p and q.

The puzzle parameters 510 and the encrypted key 512 are provided in the OP_RETURN output to render the puzzle parameters 510 available to other users when the puzzle transaction Tx₁ 502B is committed to the blockchain.

The solution provider uses the puzzle parameters 510 provided in the transaction Tx₁ 502B to compute the solution at step A. The solution computed by the solution provider is referred to as a candidate solution and denoted sol_{C}. The solution provider computes the candidate solution using sol_{C}=a²^{^{t}} mod n in at least the minimum solution time T.

The solution provider then computes a candidate private key sk_{C} using the candidate solution sol_{C} and the encrypted key Cₛₖ 512, step B. The candidate private key is derived using sk_{C}=Cₛₖ−sol_{C} mod n. The solution provider then uses the candidate private key to generate a candidate public key sk_{C}·G 514, step C.

The solution provider generates solution transaction Tx₂ 504C and provides in a first unlocking script 522B the candidate public key sk_{C}·G 514.

When the first locking script 520B and first unlocking script 522B are run together, the first locking script 520B is configured to compute a hash of the candidate public key 514, step D, and verify that the hash of the candidate public key is equal to the hash of the target public key, step E, and thus verify that the solution provider has computed the solution correctly in at least the minimum computation time T.

The locking script 520B is also configured to check that the signature 518 provided in the unlocking script 522B is correct with respect to the public key sk_{C}·G, step F. That is, the locking script checks that sk_{C} has been used to generate the signature sig 518.

The solution provider is able to spend the UTXO associated with the first locking script 520B if the hashes match, which is the case if sk_{C} is equal to sk_{T}, and if the signature 518 has been computed using the private key sk_{C}.

### 5.2.2.2 Single User can Spend

The previous construction can be adapted to address funds to a specific recipient with public key P_{A} in a timed basis. For this, the challenger sets the transaction to spend to (sk_{A}+sol)·G, where sol=a²^{^{t}}^{mod φ(n)} mod n and sk_{A} is the private key of the user allowed to spend the UTXO.

It is possible for a challenger to compute (sk_{A}+sol)·G without knowing sk_{A} using the distributivity property of the elliptic curve scalar multiplication:

$$( s {k}_{A} + sol ) \cdot G = {sk}_{A} \cdot G + sol \cdot G = {P}_{A} + sol \cdot G$$

Thus, the challenger can lock the UTXO to the user corresponding to private key sk_{A} provided they know the user's public key P_{A}.

The challenger generates the blockchain transaction with a first locking script, corresponding to a first UTXO, which comprises a hash of the public key h((sk_{A}+sol)·G) and the puzzle parameters a, t, and n. The puzzle parameters are included in the OP_RETURN so that a puzzle solver is able to compute the solution. Note that no encrypted key is provided in this construction since the puzzle solver knows their private key sk_{A}.

The locking script may be as follows:

Locking script :
OP_DUP OP_HASH <h((skA + sol) · G )>
OP_EQUALVERIFY OP_CHECKSIG
OP_RETURN <puz = (a, t)> <params = (n)>

The puzzle solver derives the solution sol, and uses this to generate the public key (sk_{A}+sol)·G, which is provided in the first unlocking script of the solution transaction. The public key (sk_{A}+sol)·G is said to be derived from the solution, since the puzzle solver must find the solution to generate the public key. The puzzle solver also provides a signature sig generated using the private key (sk_{A}+sol) to prove that it is the owner of sk_{A} and has derived the solution sol.

The unlocking script may be as follows:

Unlocking script:
<sig> <(sk_{A} + sol) · G>

The locking script is configured to generate a hash of the provided public key (sk_{A}+sol)·G and verify that it is equal to the hash h((sk_{A}+sol)·G) provided in the unlocking script.

The locking script is further configured to check that the signature provided in the unlocking script is correct and has been computed using the private key (sk_{A}+sol).

Only the user with knowledge of the secret key sk_{A} can spend the UTXO by computing the solution sol to the puzzle and spending it with the private key sk_{A}+sol.

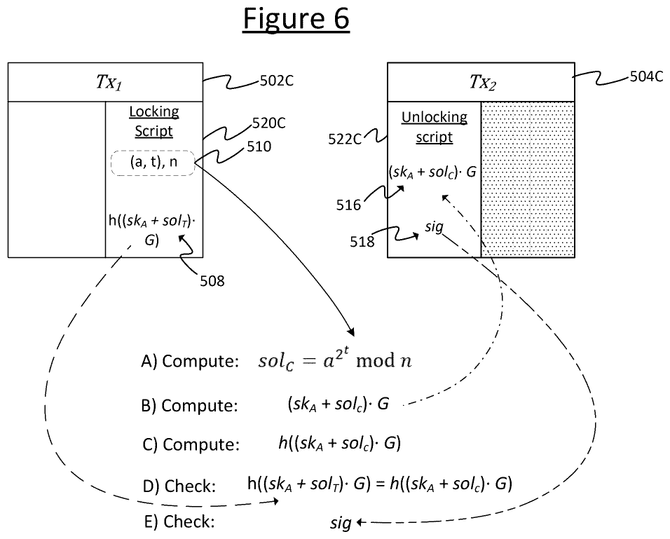

FIG. 6 illustrates the use of the single user can spend P2PKH construction set out above to time-lock a UTXO.

The challenger provides the puzzle blockchain transaction Tx₁ 502C which has a first locking script 520C comprising the puzzle parameters 510 and a portion derived from the solution 508, which here is the hash of the public key derived from the solution h((sk_{A}+sol_{T})·G). The solution used to derive the private key provided by the challenger is referred to as a target solution, denoted sol_{T}. The target solution is computed by the challenger using the large prime numbers p and q.

The puzzle parameters 510 are provided in the OP_RETURN to render the puzzle parameters 510 available to other users when the puzzle transaction Tx₁ 502C is committed to the blockchain.

The solution provider uses the puzzle parameters 510 provided in the puzzle transaction Tx₁ 502C to compute the solution at step A. The solution computed by the solution provider is referred to as a candidate solution and denoted sol_{C}. The solution provider computes the candidate solution using sol_{C}=a²^{^{t}} mod n in at least the minimum solution time T.

The solution provider then computes a candidate public key using the candidate solution sol_{C} and their own private key sk_{A}, step B. The candidate public key is derived using (sk_{A}+sol_{C})· G.

The solution provider generates solution transaction Tx₂ 504C and provides in a first unlocking script 522C the candidate public key (sk_{A}+sol_{C})·G 516.

When the first locking script 520C and first unlocking script 522C are run together, the first locking script 520C is configured to compute a hash of the candidate public key 516, step C, and verify that the hash of the candidate public key is equal to the hash of the target public key, step D, and thus verify that the solution provider has computed the solution correctly in at least the minimum computation time T.

The locking script 520C is also configured to check that the signature 518 provided in the unlocking script 522C is correct with respect to the public key (sk_{A}+sol_{C})·G, step E. That is, the locking script checks that sk_{A}+sol_{c} has been used to generate the signature sig 518.

The solution provider is able to spend the UTXO associated with the first locking script 520C if the hashes match, which is the case if sol_{C} is equal to sol_{T}, and if the signature 518 has been computed using the private key sk_{A}+sol_{c}.

### 5.3 Time-Locked Puzzle Chains

Time-lock puzzles, such as modular squaring puzzles, can be used to create chains of puzzles enabling the creation of chains of transactions or locked UTXOs. A time-locked chain of transactions is made of N transactions [Tx₁, . . . , Tx_{N}] that can be only spent at increasing times [t₁, . . . , t_{N}] respectively.

### 5.3.1 Anyone can Spend

A chain of transactions is provided using linked, sequential modular squaring puzzles. The puzzles can be linked by setting the solution of one puzzle as the parameter that needs to be squared repeatedly in the next puzzle. Therefore, only the first transaction in the chain needs to specify what the value a is. Finding the solution to a puzzle in transaction Txᵢ allows a user to solve the puzzle in the next transaction Txᵢ₊₁.

To create a puzzle chain, the challenger proceeds as follows:
1. Call SETUP(1^{k}) for a given security parameter k to generate (params, secret) and keep the value secret private.
2. Select N time parameters t₁, . . . , t_{N} to determine the solving time for each puzzle (optionally, select t to be the same for all puzzles).
3. Call GENPUZ(t₁) to generate the first puzzle puz=(a, t₁).
4. Using secret generated in step 1, compute φ(n)=(p−1)(q−1).
5. Precompute the solution
mod n using puz, params, and φ(n).
6. Sequentially precompute all

$$s o {l}_{i} = s o {l}_{i - 1}^{{2}^{{t}_{i}} mod φ ( n )}$$

mod n for 2≤i≤n using solᵢ₋₁, params, tᵢ, and φ(n).
7. Randomly generate N private keys sk₁ . . . sk_{N} and encrypt each secret key skᵢ as Cₛₖ_{ᵢ}=skᵢ+solᵢ mod n.
8. Create the P2PKH locking scripts used to lock each of the N transactions with private keys sk₁ . . . sk_{N}.

Before publishing all the N transactions on the blockchain, the challenger includes in the OP_RETURN data of transaction Tx₁ the time parameter tᵢ of the puzzle (additionally the value a in the first transaction Tx₁), the parameters params=(n) and the encrypted secret key Cₛₖ_{ᵢ}.

The address h(skᵢ₊₁·G) that can spend the next UTXO in the chain is also included so that the next transaction in the chain is known to users. Thus, it is possible to derive the complete chain of transaction IDs from the first transaction in the chain.

Using the time parameter tᵢ included in each transaction, users can estimate how much time is required to solve each puzzle and therefore the complete puzzle chain.

The locking and unlocking scripts for the first transaction Tx₁ are:

Locking script:
OP_DUP OP_HASH <h(sk₁ · G)>
OP_EQUALVERIFY OP_CHECKSIG OP_RETURN
<puz = (a, t₁))> <params = (n)> <Cₛₖ_{₁} = sk₁ + a²^{^{t}} mod n> <h(sk₂ · G)>
Unlocking script:
<sig> <sk₁ · G>

The locking and unlocking scripts for the i-th transaction Txᵢ are:

Locking script:
OP_DUP OP_HASH <h(sk₁ · G)>
OP_EQUALVERIFY OP_CHECKSIG OP_RETURN
<t₁> <params = (n)> <Cₛₖ_{ᵢ} = skᵢ + solᵢ₋₁²^{^{t}} mod n> <h(skᵢ₊₁ · G)>
Unlocking script:
<sig> <skᵢ · G>

It is noted that the locking script for each transaction for i>1 does not comprise the puzzle parameter a. Instead, the set of puzzle parameters provided comprises only t₁ and n₁ since the solution to the previous puzzle solᵢ₋₁ is squared instead of the puzzle parameter a when computing the solution solᵢ.

To derive the private keys sk₁ . . . sk_{N} necessary to spend the UTXOs in the chain, users must therefore sequentially compute the following values:

| | | |
|---|---|---|
| Tx₁ | → | sol₁ = a²^{^{t}}¹ mod n |
| Tx₂ | → | sol₂ = sol₁²^{^{t}}² mod n |
| . . . | | . . . |
| Txᵢ | → | solᵢ = solᵢ₋₁²^{^{t}}ⁱ mod n |
| Txᵢ₊₁ | → | solᵢ₊₁ = solᵢ²^{^{t}}ⁱ⁺¹ mod n |
| . . . | | . . . |
| Tx_{N} | → | sol_{N} = sol_{N-1}²^{^{t}}^{N} mod n |

From the recursive structure of the puzzle chain, computing solᵢ requires computing all solⱼ for j<i. Therefore, only users that have computed the solutions for all the puzzles in the chain can spend the last transaction Tx_{N}.

The puzzle chain construction allows the decomposition of a single hard puzzle with time parameter t_{hard_puzzle} into N sub puzzles with time parameters t₁, . . . , t_{N} where t_{hard_puzzle}=Σᵢ tᵢ. Solving all the sub puzzles can only be done sequentially and is therefore equivalent in time to solving the hard puzzle. Instead of getting a single reward for solving one hard puzzle, users are incentivised to perform the smaller computations by receiving a small reward whenever they solve a sub puzzle.

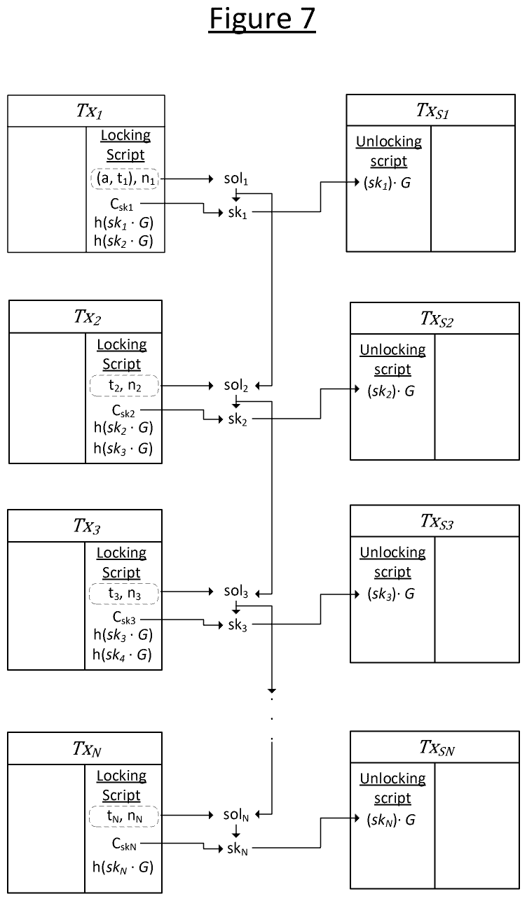

FIG. 7 illustrates how the use of the anyone can spend P2PKH construction to time-lock a UTXO shown with respect to FIG. 5 can be extended to time-lock a chain of transactions. It will be appreciated that it is the UTXOs of the transactions that are time-locked, rather than the transactions themselves.

The challenger provides a first transaction Tx₁ with a locking script providing a first set of parameters a, t₁, and n₁ corresponding to a solution of a first time-lock puzzle sol₁ and a first encryption key Cₛₖ₁ in the OP_RETURN. The locking script also comprises the hash derived from the solution of a first time-lock puzzle, here h(sk₁·G)), and the hash derived from the solution of the 2^{nd} time-lock puzzle, here h(sk₂·G).

The challenger also generates subsequent transactions for each Txᵢ for 2≤i≤N, wherein N is the total number of transactions in the chain. Each of these transactions comprises a locking script providing a set of second puzzle parameters tᵢ and nᵢ, corresponding to a solution of an i^{th} time-lock puzzle solᵢ, and an i^{th} encryption key Cₛₖᵢ in the OP_RETURN. The locking script also comprises the hash derived from the solution of the i^{th} time-lock puzzle, here h(skᵢ·G). For each Txᵢ for 2≤i<N, the OP_RETURN also includes the hash derived from the solution of the (i+1)th time-lock puzzle, here h(skᵢ₊₁·G).

The transactions Txᵢ are committed to the blockchain. Note that in this embodiment, any puzzle solver can unlock the UTXO provided they compute the correct solution.

The puzzle solver computes the first solution sol₁ using the first set of parameters provided in the first transaction Tx₁. The puzzle solver then uses the first solution sol₁ together with the first encryption key Cₛₖ₁ provided in the first transaction Tx₁ to derive the first private key sk₁.

The puzzle solver generates a hash of the public key derived from the first private key h(sk₁·G). The puzzle solver generates a first spending transaction Tx_{S1} which comprises an unlocking script comprising the public key sk₁·G.

The public key provided in the unlocking script of Tx_{S1} is checked against the hash provided in the locking script of Tx₁ to verify that the puzzle solver has calculated the solution correctly, and the signature provided in the unlocking script of Tx_{S1} is checked to verify that it is generated from the private key sk₁.

Once the puzzle solver has computed the first solution sol₁, they are able to compute the solution to the second time-lock puzzle sol₂ using sol₁ and the set of second puzzle parameters provided in a second transaction Tx₂. The second solution sol₂ is used together with the second encryption key Cₛₖ₂ to derive the second private key sk₂.

The puzzle solver uses the second private key sk₂ to generate the unlocking script of a second spending transaction Tx_{S2}.

The steps are repeated for each transaction Txᵢ until the puzzle solver computes sol_{N} and from this sk_{N} for providing in the unlocking script of the N^{th} spending transaction Tx_{SN}.

Each transaction Txᵢ defines an amount of digital asset to be transferred to the puzzle solver for providing the solution corresponding to that transaction.

It will be appreciated that while the hash derived from the solution to the next time-lock puzzle h(skᵢ₊₁·G) is provided in the locking script of each transaction Txᵢ in FIG. 7, the hashes may instead be sent off-chain. The purpose of providing this hash to the puzzle solver, whether in the transaction locking script or off-chain, is so that the puzzle solver can identify the next transaction in the chain.

It will be appreciated that the amount locked by the locking script in each transaction may also include an amount sufficient to cover the transaction fees of the spending transaction. Alternatively, the puzzle solver may be required to pay the transaction fee when providing the transactions.

### 5.3.2 Single User can Spend

In the previously described puzzle chain construction, anyone can spend the UTXOs in the chain. This can be modified so that a single user with public key P_{A}=sk_{A}·G can spend the UTXOs in the chain, using the idea described in section 5.2.2.2.

For this, the challenger sets transaction Txᵢ to spend to (sk_{A}+solᵢ)·G, where sol²^{^{ti}}ᵢ₋₁

mod n and sk_{A} is the private key of the user allowed to spend the UTXOs. The first transaction Tx₁ spends to (sk_{A}+sol₁)·G where sol₁=a²^{ₜᵢ}
mod n.

The locking and unlocking scripts for the first transaction Tx₁ are:

Locking script :
OP_DUP OP_HASH <h((sk_{A} + sol₁) · G )>
OP_EQUALVERIFY OP_CHECKSIG
OP_RETURN <puz = (a, t₁)> <params = (n)> < h((sk_{A} + sol₂) · G)>
Unlocking script:
<sig> <(sk_{A} + sol₁) · G>

The locking and unlocking scripts for the i-th transaction Txᵢ are:

Locking script :
OP_DUP OP_HASH <h((sk_{A} + solᵢ) · G )>
OP_EQUALVERIFY OP_CHECKSIG
OP_RETURN <tᵢ> <params = (n)> < h((sk_{A} + solᵢ₊₁) · G)>
Unlocking script:
<sig> <(sk_{A} + solᵢ) · G>

Only the user with knowledge of the secret key sk_{A} can spend the UTXOs in the chain by computing the solutions solᵢ to the puzzles and signing the spending transactions with private keys sk_{A}+solᵢ.

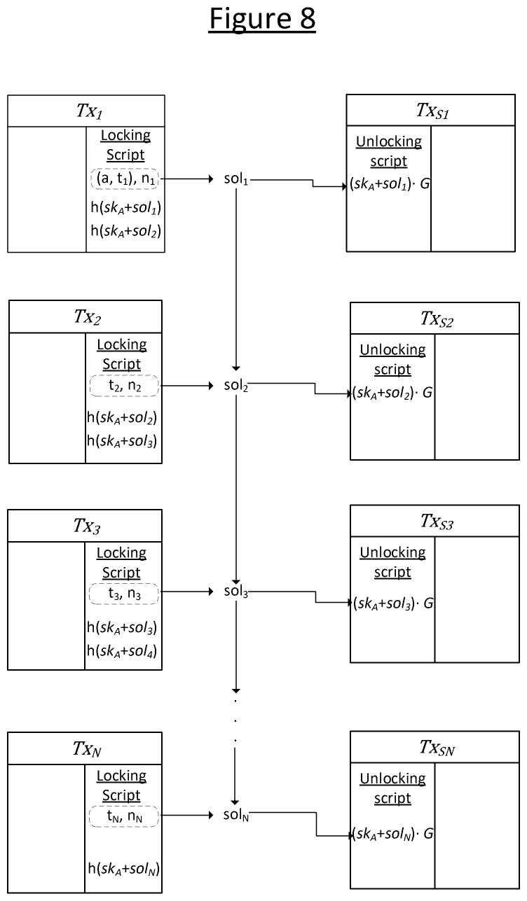

FIG. 8 illustrates how the use of the single user can spend P2PKH construction to time-lock a UTXO as shown with reference to FIG. 6 can be used in transaction chains. It will be appreciated that it is the UTXOs of the transactions that are time-locked, rather than the transactions themselves.

The challenger provides a first transaction Tx₁ with a locking script providing a first set of parameters a, t₁, and n₁ corresponding to a solution of a first time-lock puzzle sol₁ in the OP_RETURN output. The locking script also comprises the hash derived from the solution of a first time-lock puzzle, here h((sk_{A}+sol₁)·G), where sk_{A} is the private key of the predefined puzzle solver, as well as the hash derived from the solution of the 2^{nd} time-lock puzzle, here h((sk_{A}+sol₂)·G).

The challenger also generates subsequent transactions for each Txᵢ for 2≤i≤N. Each of these transactions comprises a locking script providing a set of second parameters tᵢ and nᵢ corresponding to a solution of an i^{th} time-lock puzzle solᵢ in the OP_RETURN output. The locking script also comprises the hash derived from the solution of the i^{th} time-lock puzzle, here h((sk_{A}+solᵢ)·G). For each Txᵢ for 2≤i<N, the OP_RETURN also includes the hash derived from the solution of the (i+1)th time-lock puzzle, here h((sk_{A}+solᵢ₊₁)·G).

The transactions Txᵢ are committed to the blockchain.

The puzzle solver, who is the owner of sk_{A}, computes the first solution sol₁ using the first set of parameters provided in the first transaction Tx₁.

The puzzle solver generates a public key derived from their private key sk_{A} and the first solution sol₁, (sk_{A}+sol₁)·G. The puzzle solver generates a first spending transaction Tx_{S1} which comprises an unlocking script comprising (sk_{A}+sol₁)·G.

The public key provided in the unlocking script of Tx_{S1} is checked against the hash provided in the locking script of Tx₁ to verify that the puzzle solver has calculated the solution correctly, and the signature provided in the unlocking script is checked to verify that it was generated using the private key (sk_{A}+sol).

Once the puzzle solver has computed the first solution sol₁, they are able to compute the solution to the second time-lock puzzle sol₂ using sol₁ and the second set of puzzle parameters provided in the locking script of the second transaction Tx₂.

The puzzle solver uses the second solution sol₂ to generate the unlocking script of a second spending transaction Tx_{S2}.

The steps are repeated for each transaction Tx₁ until the puzzle solver computes sol_{N} for providing in the unlocking script of the N^{th} spending transaction Tx_{SN}.

As set out above, the hash derived from the solution to the next time-lock puzzle h(skᵢ₊₁·G) may be sent off-chain to the puzzle solver off-chain, rather than being provided in the locking script of the transaction.

As described with reference to FIG. 7, each transaction Txᵢ defines an amount of digital asset to be transferred to the puzzle solver for solving the puzzle provided in the transaction Txᵢ. Note here that the puzzle solver is the owner of sk_{A}.

Time-locked puzzle chains where a single user can spend could be used, for example, to implement fixed-income securities such as fixed-rate bonds. A fixed-rate bond is a bond that pays the same level of interest over its entire term. The emitter of a bond could create a chain of transactions paying back the holder. The transactions are time-locked in a chain so that the holder is able to claim his coupons at regular intervals and in sequence only. Upon maturity of the bond, the holder will receive back the initial principal amount from the last UTXO in the chain. This solution requires continuous computation of the solution to the puzzles, sometimes for a very long period as a bond may have a maturity of a few decades. The computation can be outsourced to an external server which will do the computation on behalf of the holder. Even if the external server learns the solution to the puzzle, our construction guarantees that it won't be able to spend the time-locked transaction as this requires knowledge of the holder's secret key.

### 5.3.3 Chained UTXOs

The methods provided above for chaining transactions may be modified to chain outputs of a single transaction, such that each output of the transaction can only be spent once the solution for the previous output in the chain has been computed.

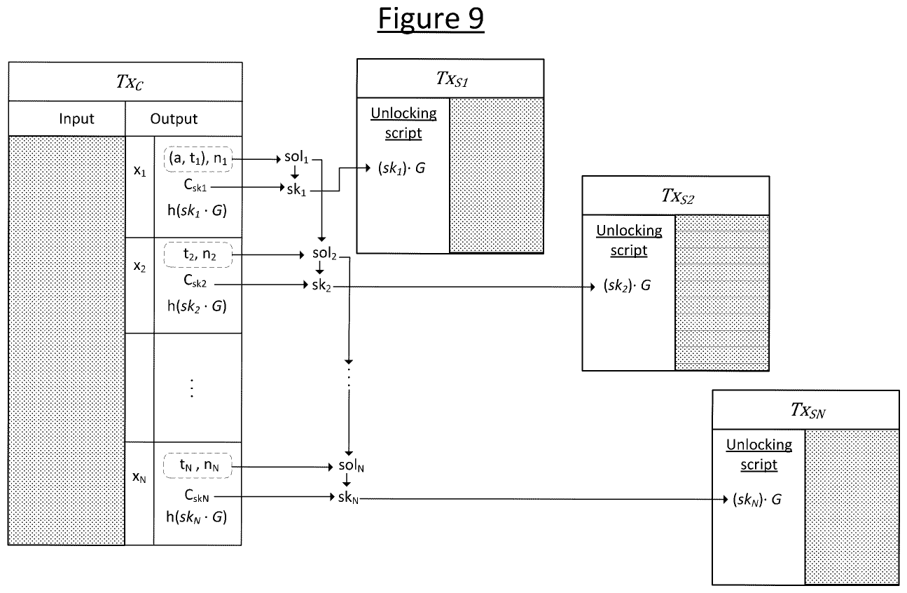

FIG. 9 shows an example transaction comprising chained UTXOs. The UTXOs in this example can be spent by any solution provider who validly computes the solution to the time-puzzles. However, it will be appreciated that the UTXOs may be locked such that only a single user can spend, following the method set out in section 5.3.2.

A chain puzzle transaction Tx_{C} comprising a set of outputs is provided by the challenger. Each output locks an amount of digital asset xᵢ with a locking script. The locking script defines the set of puzzle parameters and the encryption key. The set of puzzle parameters and the encryption key may be included in an OP_RETURN output. The unlocking script comprises public key derived from the solution, skᵢ·G.

For i=1, the set of puzzle parameters comprises a, n₁, and t₁, while for i>1, the set of puzzle parameters comprises nᵢ and tᵢ since the solution solᵢ₋₁ for the previous output in the chain is used to compute the solution solᵢ.

The puzzle solver uses the information provided in the OP_RETURN output to derive the solution solᵢ and the private key skᵢ for generating the unlocking script of each of a set of solution transactions Tx_{Si}. Each spending transactions corresponds to one of the time-locked outputs of the chain transaction Tx_{C}.

For each output i>1, the puzzle solver uses the solution solᵢ₋₁ corresponding to the previous output in the chain, along with the puzzle parameters provided in the OP_RETURN output, to compute the solution solᵢ, and thus the unlocking script for the i^{th} solution transaction.

The puzzle solver therefore must compute the solution transactions sequentially, such that each UTXO of the chain transaction can only be spent after a different, and sequentially larger, minimum solving time. When a puzzle solver provides solution transaction Tx_{α}, corresponding to the α^{th} output of the chain, all output for i>α remain locked, while those for i≤α can or have been spent.

Providing chained outputs in a single chain transaction reduces the storage requirements resulting from the puzzle chain when compared to the methods provided in section 5.3.1 and 5.3.2, i.e, methods where each chained UTXO is provided in a different transaction.

### 5.3.4 Template Puzzle Transactions

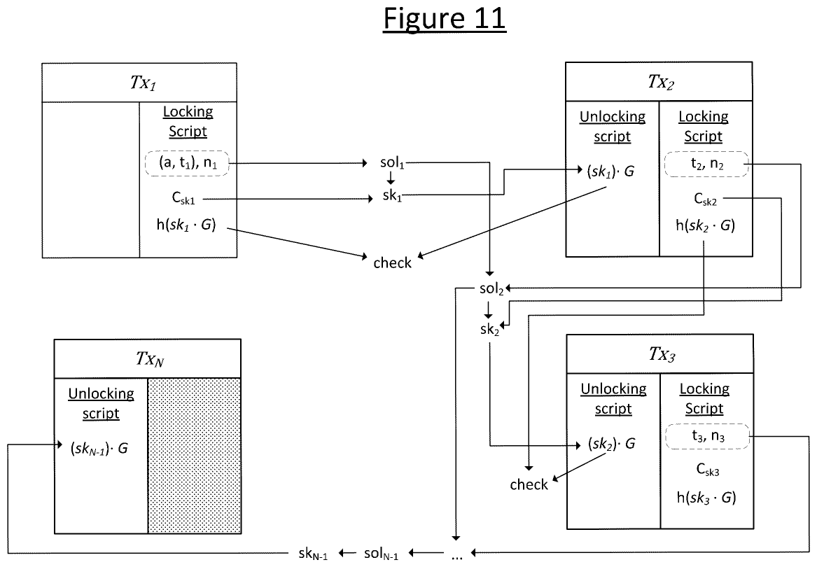

The chained transactions as described above with reference to FIGS. 7 and 8 may instead be provided in a linked set of chained transactions. FIG. 11 shows an example of such a linked set using the anyone can spend method. It will be apricated that this method may be modified to allow for the single user can spend method.

The challenger provides a first transaction Tx₁ with a locking script providing a first set of parameters a, t₁, and n₁ corresponding to a solution of a first time-lock puzzle sol₁ and a first encryption key Cₛₖ₁ in the OP_RETURN. The locking script also comprises the hash derived from the solution of a first time-lock puzzle, here h(sk₁·G).

The challenger also generates template transactions for each Txᵢ for 2≤i<N, wherein N is the total number of transactions in the chain. Each of these transactions comprises a locking script providing a set of second puzzle parameters tᵢ and nᵢ, corresponding to a solution of an i^{th} time-lock puzzle solᵢ, and an i^{th} encryption key Cₛₖᵢ in the OP_RETURN. The locking script also comprises the hash derived from the solution of the i^{th} time-lock puzzle, here h(skᵢ·G).

The first transaction Tx₁ is committed to the blockchain, while the template transactions are made available to one or more puzzle solvers. Note that in this embodiment, any puzzle solver can unlock the UTXO provided they compute the correct solution.

The puzzle solver computes the first solution sol₁ using the first set of parameters provided in the first transaction Tx₁. The puzzle solver then uses the first solution sol₁ together with the first encryption key Cₛₖ₁ provided in the first transaction Tx₁ to derive the first private key sk₁.

The puzzle solver generates the public key sk₁·G using the first private key. The puzzle solver uses the template second transaction to generate a second transaction Tx₂ which comprises the locking script provided by the challenger in the template transaction and an unlocking script comprising the public key sk₁·G.

The public key provided in the unlocking script of Tx₂ is checked against the hash provided in the locking script of Tx₁ to verify that the puzzle solver has calculated the solution correctly, and the signature provided in the unlocking script is checked to verify that it was generated using the private key sk₁.

Once the puzzle solver has computed the first solution sol₁, they are able to compute the solution to the second time-lock puzzle sol₂ using sol₁ and the set of second puzzle parameters provided in the locking script of the second transaction Tx₂. The second solution sol₂ is used together with the second encryption key Cₛₖ₂ to derive the second private key sk₂.

The puzzle solver uses the second private key sk₂ to generate the unlocking script of a third transaction Tx₃, which comprises the locking script defined by the challenger in the template of the third transaction.

The steps are repeated for each transaction Txᵢ until the puzzle solver computes sol_{N-1} and from this sk_{N-1} for providing in the unlocking script of the N^{th} transaction Tx_{N}.

For the puzzle solver to know about the order of the transactions, the hash derived from the next solution in the chain may be provided in the locking script of the template transaction, as set out with respect to FIGS. 7 and 8 above. Alternatively, the order could be communicated by associating each template transactions with an index corresponding to their order in the chain.

The first transaction Tx₁ defines a total amount of digital asset to be transferred to the puzzle solver over the whole puzzle chain. For each template transaction for 1<i<N, the locking script provided by the challenger is associated with an amount of digital asset to be locked in the transaction, and thus an amount to be transferred to the puzzle solver.

For example, Tx₁ defines a total amount of digital asset x₁. The template for Tx₂ defines that an amount x₂=x₁−y₁ is locked by the locking script of Tx₂, where y₁ is the amount of digital asset to be assigned to the puzzle solver for computing sol₁. Similarly, the template for Tx₃ defines that an amount x₃=x₁−y₁−y₂ is locked by the locking script of Tx₃, and so on.

The puzzle solver also provides an additional output when generating each transaction from the template transaction which pays them the amount yᵢ.

The amount of digital asset locked in the penultimate transaction Tx_{N-1} is equal to the final amount to be transferred to the puzzle solver.

It will be appreciated that the amount locked by the locking script in each transaction may also include an amount sufficient to cover the transaction fees. Alternatively, the puzzle solver may be required to pay the transaction fee when providing the transactions.

However, there is no guarantee that users will not modify the template and break the chain of transactions. This can be overcome with the use of the pseudocode PUSHTX, which can be used to enforce that a transaction Tx; can only be spent by the next transaction Txᵢ₊₁ in the chain and at the same time enable the challenger to publish the complete chain on the blockchain.

### 5.4 General Method

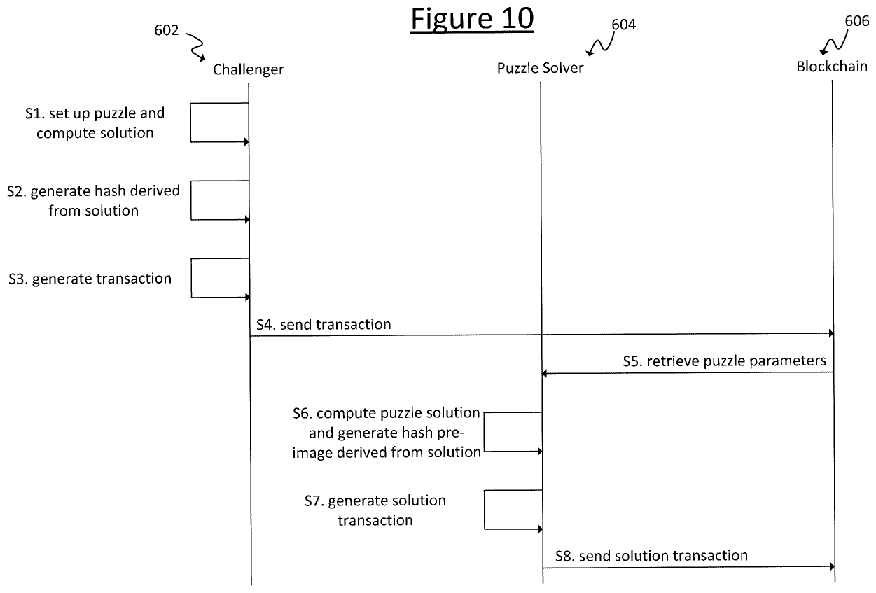

FIG. 10 shows an example method for implementing the time-lock UTXOs as described above.

At step 1, the challenger 602 sets up the puzzle by randomly choosing p and q, and from these values computing n. The challenger 602 also randomly selects the parameter a, and determines a suitable time parameter t. The challenger 602, using p, q, a, and t, computes the solution to the time-lock puzzle using sol=a²^{^{t}}^{mod φ(n)} mod n.

At step 2, the challenger 602 generates the hash derived from the solution to the time-lock puzzle. A number of variations for this hash have been presented above, and the value to be hashed depends at least in part on who is eligible to spend the UTXO, i.e. whether anyone or only a single party can pay. In some embodiments, the challenger 602 at step 2 defines a private key sk and encrypts this private key using the solution to generate the encryption key Cₛₖ.

At step 3, the challenger 602 generates the puzzle transaction Tx₁ 502, in which the challenger 602 provides the puzzle parameters n, a, and t, and the hash derived from the solution to the time-lock puzzle in the locking script.

At step 4, the challenger 602 makes the transaction Tx₁ available to one or more nodes of the blockchain 606 for committing to the blockchain 606.

At step 5, the puzzle solver 604 retrieves, from the blockchain 606, the puzzle parameters n, a, and t, and any further information provided in the OP_RETURN output, for example the encryption key Cₛₖ if provided.

At step 6, the puzzle solver 604 computes the puzzle solution using the puzzle parameters n, a, and t, using sol=a²^{^{t}} mod n. The puzzle solver uses the solution to generate a hash pre-image, for example sk·G or (skᵢ+sol)·G, derived from the puzzle solution.

At step 7, the puzzle solver 604 uses the hash pre-image derived from the solution to generate an unlocking script for the solution transaction Tx₂ 504.

The solution transaction Tx₂ 504 is sent to one or more nodes of the blockchain 606 for committing to the blockchain 606 at step 8.

In some embodiments, multiple puzzle solvers 604 may attempt to solve the puzzle and subsequently provide the solution transaction 504. Only the first solution transaction provided which comprises the hash pre-image corresponding to the solution is committed to the blockchain.

### 6. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method for generating a puzzle blockchain transaction, the method comprising:
providing a first locking script of the puzzle blockchain transaction, the first locking script corresponding to a first unspent transaction output and comprising a hash value derived from a target solution of a time-lock puzzle, and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, wherein the locking script is configured to:
   when executed with a first unlocking script of a solution blockchain transaction, verify a candidate solution, computed using the set of puzzle parameters, provided in the first unlocking script of the solution blockchain transaction based on the hash value; and
making the puzzle blockchain transaction available to one or more nodes of a blockchain network.

Statement 2. The method of statement 1, wherein the hash value is a hash of a public key derived using the target solution to the time-lock puzzle.

Statement 3. The method of statement 2, wherein the public key is derived from a private key, wherein the private key is derived from a private key of a predefined recipient and the target solution.

Statement 4. The method of statement 3, wherein the private key is the sum of the private key of the predefined recipient and the target solution.

Statement 5. The method of statement 2, wherein the public key is derived from a private key, wherein the private key is a randomly generated private key, wherein the method further comprises randomly generating the private key.

Statement 6. The method of statement 5, wherein the method further comprises encrypting the private key based on the target solution.

Statement 7. The method of statement 6, wherein the first locking script further comprises the encrypted private key for rendering available when the puzzle blockchain transaction is committed to the blockchain.

Statement 8. The method of statement 1 or any statement dependent thereon, wherein the first locking script further comprises a second hash value, wherein the second hash value is derived from a second target solution to a second time-lock puzzle and a set of second puzzle parameters of the second time-lock puzzle and corresponds to a second unspent transaction output, wherein the second unspent transaction output corresponds to a second locking script comprising the second hash value.

Statement 9. The method of statement 8, wherein the second unspent transaction output and the second locking script are provided in a second puzzle blockchain transaction.

Statement 10. The method of statement 8, wherein the second unspent transaction output and the second locking script are provided in the puzzle blockchain transaction.

Statement 11. The method of statement 8 or any statement dependent thereon when dependent on statement 2, wherein the second hash value is a hash of a second public key derived using the target solution of the second time-lock puzzle.

Statement 12. A computer-implemented method for generating a solution blockchain transaction for unlocking a time-locked unspent transaction output of a puzzle blockchain transaction, the puzzle blockchain transaction comprising a first locking script of the puzzle blockchain transaction, the first locking script corresponding to a first unspent transaction output and comprising a hash value derived from a target solution to a time-lock puzzle and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, the method comprising:
generating, based on the set of puzzle parameters, a candidate solution to the time-lock puzzle;
providing, in a first unlocking script of the solution blockchain transaction, a portion derived from the candidate solution; and
making the solution blockchain transaction available to one or more nodes of a blockchain network.

Statement 13. The method of statement 12, wherein the portion derived from the candidate solution is a public key derived using the candidate solution.

Statement 14. The method of statement 13, wherein the method further comprises:
generating a private key, wherein the private key is generated using the candidate solution and a private key of a user generating the candidate solution;
deriving the public key using the generated private key;
generating a signature using the private key; and
providing the signature in the unlocking script.

Statement 15. The method of statement 13, wherein the first locking script of the puzzle blockchain transaction further comprises an encrypted private key, wherein the encrypted private key is a randomly generated private key encrypted based on the target solution, wherein the method further comprises:
determining the private key based on the candidate solution and the encrypted private key;
deriving the public key using the determined private key;
generating a signature using the private key; and
providing the signature in the unlocking script.

Statement 16. The method of any of statements 12 to 15, wherein the first locking script of the puzzle blockchain transaction further comprises a second hash value, wherein the second hash value is derived from a second target solution to a second time-lock puzzle and a set of second puzzle parameters of the second time-lock puzzle and corresponds to a second unspent transaction output, wherein the second unspent transaction output corresponds to a second locking script comprising the second hash value, wherein the method further comprises:
generating, based on the set of second puzzle parameters and the candidate solution to the time-lock puzzle, a second candidate solution to the second time-lock puzzle;
providing, in a second unlocking script of a second solution blockchain transaction, a second portion derived from the second candidate solution; and
making the second solution blockchain transaction available to one or more nodes of a blockchain network.

Statement 17. The method of statement 16 when dependent on statement 14 or statement 15, wherein the private key of the second portion is derived from the second candidate solution.

Statement 18. The method of any preceding statement, wherein the time-lock puzzle is a modular squaring puzzle.

Statement 19. The method of statement 18, wherein the candidate solution is computed using:

sol=a²^{^{t}} mod n

wherein a, t, and n are puzzle parameters, wherein 1<a<n and t>0.

Statement 20. The method of statement 19, wherein the puzzle parameter n is defined by:

modulus n=pq

wherein p and q are large prime numbers.

Statement 21. The method of statement 20, wherein the target solution is computed using:

sol=a²^{^{t}}^{mod φ(n)} mod n

wherein φ(n)=(p−1)(q−1), wherein the set of secret puzzle parameters comprises p and q.

Statement 22. The method according to statement 19 or any statement dependent thereon, wherein the encrypted transaction encryption key is defined by:

$${C}_{k} = K + sol mod n .$$

Statement 23. The method of statement 19 or any statement dependent thereon when dependent on statement 8 or statement 16 or any statements dependent thereon, wherein the set of second puzzle parameters comprises the puzzle parameters t and n, wherein the puzzle parameter a is not included in the second locking script, wherein the candidate solution to the time-lock puzzle is used as the puzzle parameter a when generating the candidate solution to the second time-lock puzzle.

Statement 24. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 23.

Statement 25. A computer program embodied on computer-readable storage and configured so as, when run on one or more processors, to perform the method of any of statements 1 to 23.

1. A computer-implemented method for generating a puzzle blockchain transaction, the method comprising:
providing a first locking script of the puzzle blockchain transaction, the first locking script corresponding to a first unspent transaction output and comprising a hash value derived from a target solution of a time-lock puzzle, and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, wherein the locking script is configured to:
when executed with a first unlocking script of a solution blockchain transaction, verify a candidate solution, computed using the set of puzzle parameters, provided in the first unlocking script of the solution blockchain transaction based on the hash value; and
making the puzzle blockchain transaction available to one or more nodes of a blockchain network.

2. The method of claim 1, wherein the hash value is a hash of a public key derived using the target solution to the time-lock puzzle.

3. The method of claim 2, wherein the public key is derived from a private key, wherein the private key is derived from a private key of a predefined recipient and the target solution.

4. The method of claim 3, wherein the private key is the sum of the private key of the predefined recipient and the target solution.

5. The method of claim 2, wherein the public key is derived from a private key, wherein the private key is a randomly generated private key, wherein the method further comprises randomly generating the private key.

6. The method of claim 5, wherein the method further comprises encrypting the private key based on the target solution.

7. The method of claim 6, wherein the first locking script further comprises the encrypted private key for rendering available when the puzzle blockchain transaction is committed to the blockchain.

8. The method of claim 1, wherein the first locking script further comprises a second hash value, wherein the second hash value is derived from a second target solution to a second time-lock puzzle and a set of second puzzle parameters of the second time-lock puzzle and corresponds to a second unspent transaction output, wherein the second unspent transaction output corresponds to a second locking script comprising the second hash value.

9-11. (canceled)

12. A computer-implemented method for generating a solution blockchain transaction for unlocking a time-locked unspent transaction output of a puzzle blockchain transaction, the puzzle blockchain transaction comprising a first locking script of the puzzle blockchain transaction, the first locking script corresponding to a first unspent transaction output and comprising a hash value derived from a target solution to a time-lock puzzle and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, the method comprising:
generating, based on the set of puzzle parameters, a candidate solution to the time-lock puzzle;
providing, in a first unlocking script of the solution blockchain transaction, a portion derived from the candidate solution; and
making the solution blockchain transaction available to one or more nodes of a blockchain network.

13. The method of claim 12, wherein the portion derived from the candidate solution is a public key derived using the candidate solution.

14. The method of claim 13, wherein the method further comprises:
generating a private key, wherein the private key is generated using the candidate solution and a private key of a user generating the candidate solution;
deriving the public key using the generated private key;
generating a signature using the private key; and
providing the signature in the unlocking script.

15. The method of claim 13, wherein the first locking script of the puzzle blockchain transaction further comprises an encrypted private key, wherein the encrypted private key is a randomly generated private key encrypted based on the target solution, wherein the method further comprises:
determining the private key based on the candidate solution and the encrypted private key;
deriving the public key using the determined private key;
generating a signature using the private key; and
providing the signature in the unlocking script.

16. The method of claim 12, wherein the first locking script of the puzzle blockchain transaction further comprises a second hash value, wherein the second hash value is derived from a second target solution to a second time-lock puzzle and a set of second puzzle parameters of the second time-lock puzzle and corresponds to a second unspent transaction output, wherein the second unspent transaction output corresponds to a second locking script comprising the second hash value, wherein the method further comprises:
generating, based on the set of second puzzle parameters and the candidate solution to the time-lock puzzle, a second candidate solution to the second time-lock puzzle;
providing, in a second unlocking script of a second solution blockchain transaction, a second portion derived from the second candidate solution; and
making the second solution blockchain transaction available to one or more nodes of a blockchain network.

17. (canceled)

18. The method of claim 1, wherein the time-lock puzzle is a modular squaring puzzle.

19. The method of claim 18, wherein the candidate solution is computed using:
sol=a²^{^{t}} mod n
wherein a, t, and n are puzzle parameters, wherein 1<a<n and t>0.

20. The method of claim 19, wherein the puzzle parameter n is defined by:
modulus n=pq
wherein p and q are large prime numbers.

21. The method of claim 20, wherein the target solution is computed using:
sol=a²^{^{t}}^{mod φ(n)} mod n
wherein φ(n)=(p−1)(q−1), wherein the set of secret puzzle parameters comprises p and q.

22. The method according to claim 19, wherein the encrypted transaction encryption key is defined by:
$${C}_{k} = K + sol mod n .$$

23. (canceled)

24. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a puzzle blockchain transaction, the method comprising:
providing a first locking script of the puzzle blockchain transaction, the first locking script corresponding to a first unspent transaction output and comprising a hash value derived from a target solution of a time-lock puzzle, and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, wherein the locking script is configured to:
when executed with a first unlocking script of a solution blockchain transaction, verify a candidate solution, computed using the set of puzzle parameters, provided in the first unlocking script of the solution blockchain transaction based on the hash value; and
making the puzzle blockchain transaction available to one or more nodes of a blockchain network.

25. A computer program embodied on non-transitory computer-readable storage media and configured so as, when run on one or more processors, the one or more processors perform a method of generating a puzzle blockchain transaction, the method comprising:
providing a first locking script of the puzzle blockchain transaction, the first locking script corresponding to a first unspent transaction output and comprising a hash value derived from a target solution of a time-lock puzzle, and a set of puzzle parameters of the time-lock puzzle, wherein the target solution is computed using a set of secret puzzle parameters and wherein the time-lock puzzle is solvable using the set of puzzle parameter in a time equal to or greater than a minimum solving time, wherein the set of puzzle parameters does not comprise the secret puzzle parameters, wherein the locking script is configured to:
when executed with a first unlocking script of a solution blockchain transaction, verify a candidate solution, computed using the set of puzzle parameters, provided in the first unlocking script of the solution blockchain transaction based on the hash value; and
making the puzzle blockchain transaction available to one or more nodes of a blockchain network.
